(19) United States
(12) Patent Application Publication
(10) Pub. No.: US 2018/0187766 A1
(43) Pub. Date: Jul. 5, 2018

(54) Method for manufacturing a single chainring

(71) Applicant: SR SUNTOUR INC., Chang Hua (TW)

(72) Inventor: Yoshihisa Iwasaki, Nara-ken (JP)

(21) Appl. No.: 15/726,685

(22) Filed: Oct. 6, 2017

(30) Foreign Application Priority Data
Jan. 3, 2017 (TW) 106100018

(51) Int. Cl. F16H 55/30; B21D 53/26

(52) U.S. Cl. CPC F16H 55/30; B21D 53/261

(57) ABSTRACT

A method for manufacturing a single chainring (1) which prevents a chain (3) from easily falling off and is low-cost is provided. The method for manufacturing a single chainring (1) comprises a step of forming neutral teeth (A) having a thickness allowing the neutral teeth (A) to be smoothly insertable into an inner link gap of a chain (3) and further comprises one or both of a step of forming outward teeth (B) by bending a part of the neutral teeth (A) outwardly in such a manner that the outward teeth (B) are insertable into an outer link gap of the chain (3) and a step of forming inward teeth (C) by bending a part of the neutral teeth (A) inwardly in such a manner that the inward teeth (C) are insertable into the outer link gap of the chain (3).

### BACKGROUND OF THE INVENTION

### Field of the Invention

The present invention is related to a method for manufacturing a single chainring of a system, wherein a front gear is a single gear, a rear gear is a multi-stage gear, and the front single gear and the rear multi-stage gear are coupled by a chain, and is related to a method for manufacturing a single chainring which is capable of preventing a chain from easily falling off and is low-cost.

### DESCRIPTION OF THE RELATED ART

Recently, MTBs (Mountain Bikes) in which a front gear is a single gear while a rear gear is a multi-stage gear such as a 9-stage gear, 10-stage gear or 11-stage gear become more popular. In the case that the front gear is a multi-stage gear, it is difficult for a chain to fall off since a front derailleur is equipped. However, in the case that the front gear is a single gear, it is easy for the chain to fall off due to the absence of the front derailleur.

In case that the front gear is a single gear, usually, a chain detachment prevention device is additionally installed. However, due to a variety of frame shapes, installation of the chain detachment prevention device may be difficult, and a problem that the weight is increased occurs.

To solve the problem mentioned above, U.S. Pat. No. 9,182,027B2 and U.S. Pat. No. 9,062,758B2 are proposed. In the patents mentioned above, a single gear comprises thin teeth to be smoothly inserted into an inner link gap of a chain and thick teeth to be smoothly inserted into an outer link gap of the chain with the thin teeth and thick teeth being arranged alternately. As a result, inner link plates and outer link plates of the chain can be retained to prevent the chain from falling off in contrast to prior arts in which only inner link plates of a chain is retained.

US2015/0239528A1 also discloses a single gear which is similar to those as disclosed by U.S. Pat. No. 9,182,027B2 and U.S. Pat. No. 9,062,758B2 and which comprises teeth to be smoothly inserted into an inner link gap of a chain and teeth to be smoothly inserted into an outer link gap of the chain with the two kinds of teeth being arranged alternately. In contrast to the gears as proposed in U.S. Pat. No. 9,182,027B2 and U.S. Pat. No. 9,062,758B2 in which the thickness of the teeth to be inserted into the inner link gap of the chain and the thickness of the teeth to be inserted into the outer link gap of the chain are made different, the thickness of the teeth as disclosed by US2015/0239528A1 is constant, but the teeth are divided, by shifting the teeth in a thickness direction, into teeth to be inserted into the inner link gap and teeth to be inserted into the outer link gap alternately arranged, such that the chain can be prevented from falling off.

### BRIEF SUMMARY OF THE INVENTION

For production of the gears of U.S. Pat. No. 9,182,027B2 and U.S. Pat. No. 9,062,758B2, machining or machining after forging is required since the teeth having different thickness have to be arranged alternately. Therefore, such gears are very expensive. The market price of such gears is much higher than that of a normal conventional gear formed with teeth having a constant thickness.

In the gear of US2015/0239528A, the thickness of the teeth is constant, but in order to form the teeth shifted outwardly or inwardly in the thickness direction with respect to the teeth to be inserted into the inner link gap of the chain, machining or machining after forging is required for production of such a gear. Therefore, such a gear is very expensive.

In the case that the gear is made of aluminum alloy, machining or machining after forging is relatively easy. In the case that the gear is made of iron, machining becomes difficult, and hence the gear is expensive and impractical even though it is made of inexpensive iron.

The present invention aims to solve the above problems by providing a method for manufacturing a single chainring, which prevents a chain from easily fall off, facilitates to good productivity and is low-cost and which is used in a system wherein a front gear is a single gear, a rear gear is a multi-stage gear, and the front single gear and the rear multi-stage gear are coupled by the chain.

A method for manufacturing a single chainring according to the present invention comprises: a step of preparing a single chainring blank which comprises a single chainring body and a plurality of teeth formed around an outer circumference of the single chainring body and positioned in the same plane; and further comprises one or both of an outward tooth forming step for forming a plurality of outward teeth in such a manner that tooth tips of at least a part of the plurality of teeth are bent outwardly and an inward tooth forming step for forming a plurality of inward teeth in such a manner that tooth tips of at least a part of the plurality of teeth are bent inwardly, wherein the teeth which are not bent are treated as neutral teeth.

The thickness of the neutral teeth is so dimensioned that the neutral teeth are insertable into an inner link gap of a chain. The outward teeth and the inward teeth are so configured that they are not insertable into the inner link gap of the chain but insertable into an outer link gap of the chain. The chain is wound around and engaged with the single gear smoothly and prevented from easily falling off by arranging the neutral teeth and the outward teeth alternately or arranging the neutral teeth and the inward teeth alternately or arranging the neutral teeth, the outward teeth and the inward teeth in an order of the neutral tooth, the outward tooth, the neutral tooth and the inward tooth repeatedly.

### BRIEF DESCRIPTION OF THE SEVERAL VIEWS OF THE DRAWINGS

The embodiment of the invention will be described in accordance with drawings.

FIG. 1 is a front view of a single chainring according to the invention (observed from the crank side).

FIG. 2 is a side view showing 3 types of teeth (the neutral tooth A, the outward tooth B and the inward tooth C) according to the invention.

FIG. 3 shows an example of a bending process for the outward tooth B and the inward tooth C.

FIG. 4 shows a single chainring according to the present invention mounted on the right crank.

FIGS. 5, 6 and 7 are views observed from the top and showing that the 3 types of teeth are arranged alternately.

FIGS. 8, 9 and 10 are views showing a system wherein a front gear is a single chainring, a rear gear is a multi-stage gear, and the front single chainring and the rear multi-stage gear are coupled by a chain.

FIGS. 11 and 12 are views showing that the chain is wound around the single chainring according to the present invention.

FIG. 13 is a view explanatively showing chamfers of the leading flank of the outward tooth B and the inward tooth C in a rotation direction.

### DETAILED DESCRIPTION OF THE INVENTION

As shown in FIGS. 8 to 10, the present invention is related to a single chainring used in a system wherein a front gear is a single gear, a rear gear is a multi-stage gear, and the front single gear and the rear multi-stage gear are coupled by a chain.

Since the conventional gear has a constant tooth thickness allowing teeth to be insertable into the gap of inner link plates 3a (the gap of inner link plates is also referred to as “inner link gap”), the chain 3 may easily fall off from a front single gear if the chain 3 is wound around the minimum gear 5a or the maximum gear 5b of the rear multi-stage gear 5 and is deflected significantly as shown in FIGS. 8 to 10. Since only the inner link plates 3a of the chain 3 are retained in the conventional single gear, the conventional single gear is unable to deal with the situation that the chain 3 is significantly deflected. As a result, the chain may easily fall off from the single gear.

According to the present invention, a manufacturing method of a front single gear 1 is provided, wherein outer link plates 3b are certainly retained by means of alternately arranging neutral teeth A as well as outward teeth B and/or inward teeth C, as shown in FIG. 2, the neutral teeth A have a thickness smoothly insertable into the inner link gap of the chain 3, as shown in FIGS. 2 and 3, the outward teeth B have the same thickness with the teeth A and are outwardly bent so that the teeth B are insertable into the gap of outer link plates 3b (the gap of outer link plates 3b is also referred to as “outer link gap”) of the chain 3, and the inward teeth C have the same thickness with the teeth A and are inwardly bent so that the teeth C are insertable into the outer link gap of the chain 3. As such, the chain 3 is hard to fall off from the single gear even if the chain 3 is significantly deflected.

The specific manufacturing method comprises a step of preparing a single chainring blank formed with a plurality of teeth around the entire circumference, all of the teeth being neutral teeth A. As shown in FIG. 2, the neutral tooth A is formed to be slightly thinner than the gap of the inner link plates 3a of the chain 3 and is easily insertable into the gap of the inner link plates 3a of the chain 3. The manufacturing method further comprises one or both of a step of forming the outward teeth by bending a part of the teeth outwardly in such a manner that the outward teeth are not insertable into the gap of the inner link plates 3a of the chain 3 but insertable into the gap of the outer link plates 3b of the chain with a small clearance from the outer link plate 3b at the right crank side as shown in FIGS. 2 and 3 and a step of forming the inward teeth by bending a part of the teeth inwardly in such a manner that the inward teeth are not insertable into the gap of the inner link plates 3a of the chain 3 but insertable into the gap of the outer link plates 3b of the chain with a small clearance from the outer link plate 3b at the frame side as shown in FIGS. 2 and 3. Preferably, the value of L shown in FIG. 2 is in the range of 0.1 mm to 0.4 mm.

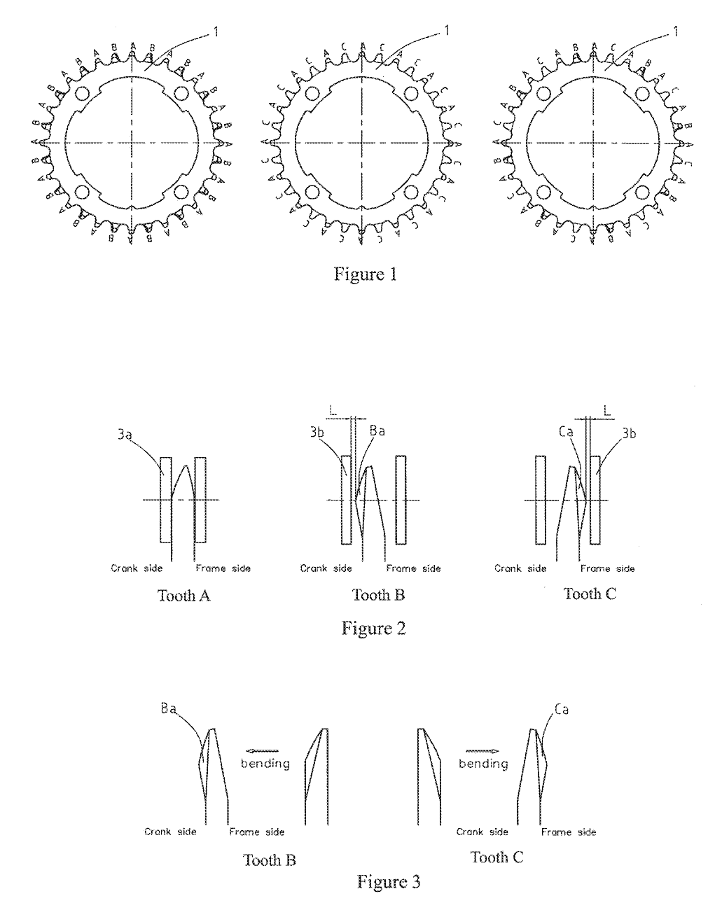

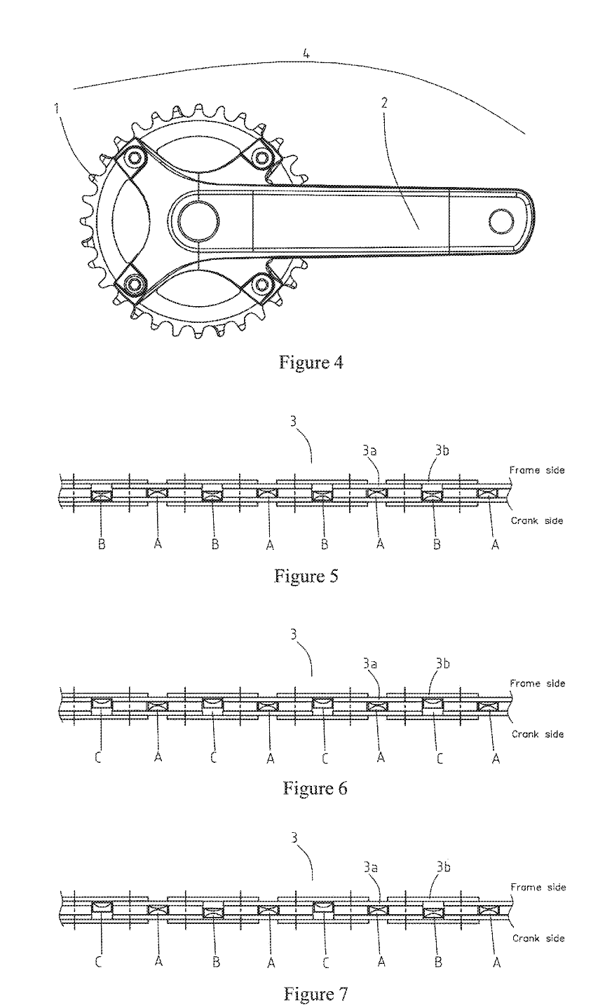

Further, the inner link plates 3a and the outer link plates 3b of the chain 3 can be retained certainly by arranging the neutral teeth A, the outward teeth B and the inward teeth C alternately as shown in FIGS. 1 and 5 to 7.

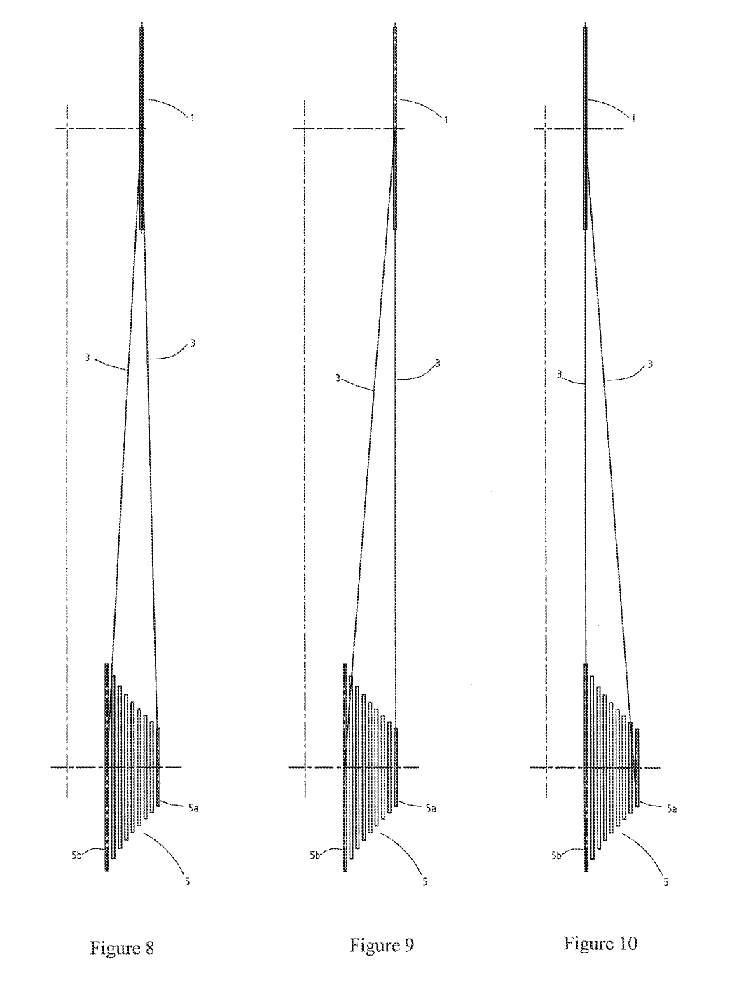

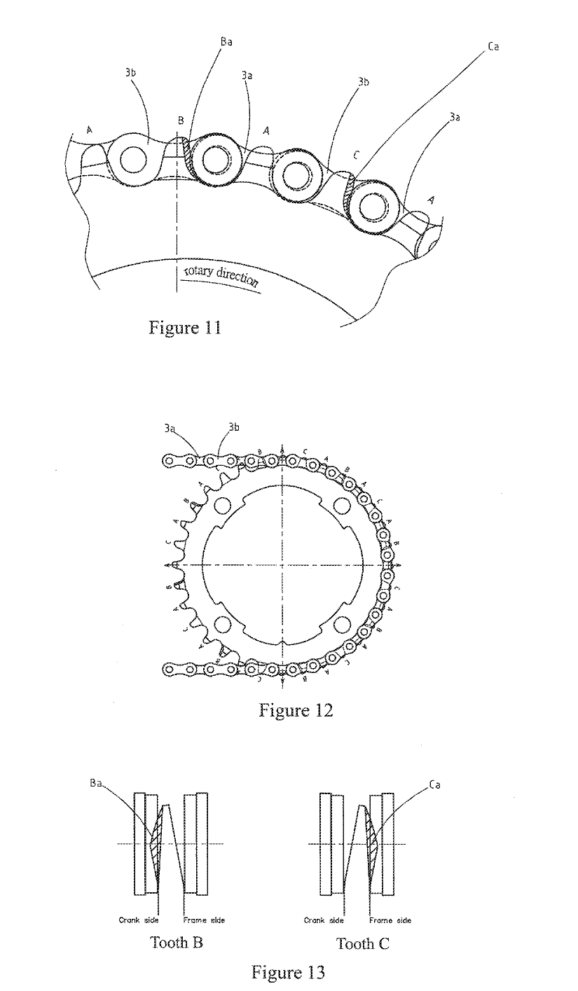

In the case that the chain 3 is deflected slightly when wound around the minimum gear 5a of the multi-stage gear 5 and is deflected greatly when wound around the maximum gear 5b as shown in FIG. 9, it is preferred that the teeth are arranged in an order of the neutral tooth A, the outward tooth B, the neutral tooth A, the outward tooth B, the neutral tooth A and the outward tooth B repeatedly as shown in FIG. 5 such that deflection of the chain 3 toward the frame side is difficult, and the outer link plates 3b of the chain 3 can be retained by the outward teeth B. In the case that the chain 3 is deflected greatly when wound around the minimum gear 5a of the multi-stage gear 5 and is deflected slightly when wound around the maximum gear 5b as shown in FIG. 10, it is preferred that the teeth are arranged in an order of the neutral tooth A, the inward tooth C, the neutral tooth A, the inward tooth C, the neutral tooth A and the inward tooth C repeatedly as shown in FIG. 6 such that deflection of the chain 3 toward the right crank side is difficult, and the outer link plates 3b of the chain 3 can be retained by the inward teeth C. In the case that the chain 3 is deflected greatly when wound on the minimum gear 5a or the maximum gear 5b of the multi-stage gear 5 as shown in FIG. 8, it is preferred that the teeth are arranged in an order of the neutral tooth A, the outward tooth B, the neutral tooth A, the inward tooth C, the neutral tooth A, the outward tooth B, the neutral tooth A and the inward tooth C repeatedly as shown in FIG. 7 such that the outer link plates 3b can be retained by the outward teeth B and the inward teeth C.

According to the invention, in order to prevent the inner link plates 3a of the chain 3 from being in contact with the leading flanks of the outward teeth B and the inward teeth C in the rotation direction, chamfers Ba and Ca are formed on the leading flanks of the outward teeth B and the inward teeth C in such a manner that the outward teeth B and the inward teeth C are in no contact with the inner link plates 3a when inserted into the outer link gap.

### Effects of the Invention

Conventionally, it has been proposed that teeth to be inserted into an inner link gap of a chain and teeth to be inserted into an outer link gap are different in the thickness and arranged alternately so as to retain any one of the inner link plates and the outer link plate, or that teeth having a constant thickness are shifted in the thickness direction so as to retain any one of the inner link plates and the outer link plates, but the conventional single gears as proposed have to be produced by means of machining due to their structure or shape, and hence the conventional single gears are very expensive.

According to the present invention, a method for manufacturing a gear which is very low-cost is provided, the method comprising a step of preparing a single chainring blank which comprises a plurality of teeth having a constant thickness insertable into an inner link gap of a chain, and further comprising one or both of a step of forming outward teeth by outwardly bending a part of the plurality of teeth in such a manner that the outward teeth are insertable into an outer link gap of the chain and a step of forming inward teeth by inwardly bending a part of the plurality of teeth in such a manner that the inward teeth are insertable into the outer link gap of the chain, wherein the teeth which are not bent are treated as neutral teeth, and the chain is prevented from easily falling off by alternately arranging the neutral teeth and the outward teeth, or alternately arranging the neutral teeth and the inward teeth, or alternately arranging the neutral teeth, the outward teeth and the inward teeth.

For production of the conventional gear, machining is difficult and is time-consuming especially in the case that material for forming the gear is iron. However, according to the present invention, productivity would not be affected by the material as the gear is manufactured by a press process, and hence a low-cost gear can be provided.

### REFERENCE NUMERALS

1 single gear
3 chain
3a inner link pate
3b outer link pate
5 rear multi-stage gear
5a minimum gear
5b maximum gear
A neutral tooth
B outward teeth
Ba chamfer
C inward teeth
Ca chamfer

What is claimed is:

1. A method for manufacturing a single chainring (1) comprising:
a step of preparing a single chainring blank which comprises a single chainring body and a plurality of teeth formed around an outer circumference of the single chainring body and positioned in a same plane;
the method further comprising one or both of an outward tooth forming step for forming a plurality of outward teeth (B) in such a manner that tooth tips of at least a part of the plurality of teeth are bent outwardly and an inward tooth forming step for forming a plurality of inward teeth (C) in such a manner that tooth tips of at least a part of the plurality of teeth are bent inwardly;
wherein the teeth which are not bent are treated as neutral teeth (A).

2. The method of claim 1, wherein the single chainring blank is so configured that a thickness of the teeth allows the teeth to be insertable into an inner link gap of a chain (3).

3. The method of claim 1, wherein the outward tooth forming step is carried out so that the outward teeth (B) are not insertable into an inner link gap of a chain (3) and are insertable into an outer link gap of the chain (3).

4. The method of claim 1, wherein the inward tooth forming step is carried out so that the inward teeth (C) are not insertable into an inner link gap of a chain (3) and are insertable into an outer link gap of the chain (3).

5. The method of claim 1, wherein the outward tooth forming step is carried out so that the neutral teeth (A) and the outward teeth (B) are arranged alternately.

6. The method of claim 1, wherein the inward tooth forming step is carried out so that the neutral teeth (A) and the inward teeth (C) are arranged alternately.

7. The method of claim 1, wherein the outward tooth forming step and the inward tooth forming step are carried out so that the neutral teeth (A), the outward teeth (B) and the inward teeth (C) are arranged in an order of the neutral tooth (A), the outward tooth (B), the neutral tooth (A) and the inward tooth (C), repeatedly.
